(19) United States
(12) Patent Application Publication
(10) Pub. No.: US 2015/0118049 A1
(43) Pub. Date: Apr. 30, 2015

(54) FLYBARLESS HELICOPTER ROTOR HEAD SYSTEM

(71) Applicant: Charley Lee Stephens, Trussville, AL (US)

(72) Inventor: Charley Lee Stephens, Trussville, AL (US)

(21) Appl. No.: 14/069,349

(22) Filed: Oct. 31, 2013

(51) Int. Cl. B64C 27/605; A63H 27/00

(52) U.S. Cl. CPC B64C 27/605; A63H 27/12
USPC 416/113

(57) ABSTRACT

A helicopter rotor head system has direct mounted mechanical phasing and pitch control levers. The system reduces drag and friction from the conventional four-point connection used today by using a two-point connection at the swash plate. Input movements from the swash plate are transmitted through a linkage arm fixed to ball bearing raced levers. The levers are ball bearing raced in two positions, with two different inner race sizes to reduce wear and side load while maintaining precision and accuracy. These levers are mounted to fixed support studs on the center hub (yoke). This causes them to set the phase of the swash plate precisely. Movements from these levers are reduced to a single connection point and allow only pitch up/down movements that transmit to blade grips through a link rod.

### BACKGROUND OF THE INVENTION

The present invention relates to radio controlled helicopter accessories and, more particularly, to a flybarless helicopter rotor head system with direct mounted mechanical phasing and pitch control levers.

Common helicopter rotor head phasing and pitch controls are bulky, requiring extra moving parts to achieve its basic function. For example, phasing levers are used to drive the swash plate and pitch input control rods extend from the swash plate to the blade grips. The phasing levers are not mounted to studs and often use the same size inner diameter ball bearings, allowing more signs of wear. Levers are only supported by a standard threaded screws which are an inaccurate way to support two bearings and can be damaged or bent easily. These functions require four connection points on the swash plate.

These connection points create more rotor head drag and friction, also adding more wear and tear. This reduces service life and increases operational costs.

As can be seen, there is a need for an improved helicopter rotor head system.

### SUMMARY OF THE INVENTION

In one aspect of the present invention, a flybarless helicopter rotor head system comprises a center hub having two protruding support studs with holes at the end thereof; a first and a second mounting lever attached to the center hub; first and second ball bearings used to attach each of the first and second mounting levers to the support studs; and a first and a second linkage arm attached to ends of the first and second mounting levers, wherein the first and second linkage arms provides a two-point attachment to a swash plate.

In another aspect of the present invention, a flybarless helicopter rotor head system comprises a center hub having two protruding support studs with threaded holes at the end thereof; a first and a second mounting lever attached to the center hub with mounting screws threaded into holes of the center hub; first and second ball bearings used to attach each of the first and second mounting levers to the support studs; and a first and a second linkage arm attached to ends of the first and second mounting levers, wherein the first and second linkage arms provides a two-point attachment to a swash plate.

These and other features, aspects and advantages of the present invention will become better understood with reference to the following drawings, description and claims.

### BRIEF DESCRIPTION OF THE DRAWINGS

FIG. 1 is a perspective view of a helicopter rotor head system attached to a swash plate, according to an exemplary embodiment of the present invention;

FIG. 2 is a perspective view of the helicopter rotor head system of FIG. 1, showing the range of motion of the linkage arms; and

FIG. 3 is an exploded perspective view of the helicopter rotor head system of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a helicopter rotor head system having direct mounted mechanical phasing and pitch control levers. The system of the present invention reduces drag and friction from the conventional four-point connection used today by using a two-point connection at the swash plate. Input movements from the swash plate are transmitted through a linkage arm fixed to ball bearing raced levers. The levers are ball bearing raced in two positions, with two different inner race sizes to reduce wear and side load while maintaining precision and accuracy. These levers are mounted to fixed support studs on the center hub (yoke). This causes them to set the phase of the swash plate precisely. Movements from these levers are reduced to a single connection point and allow only pitch up/down movements that transmit to blade grips through a link rod.

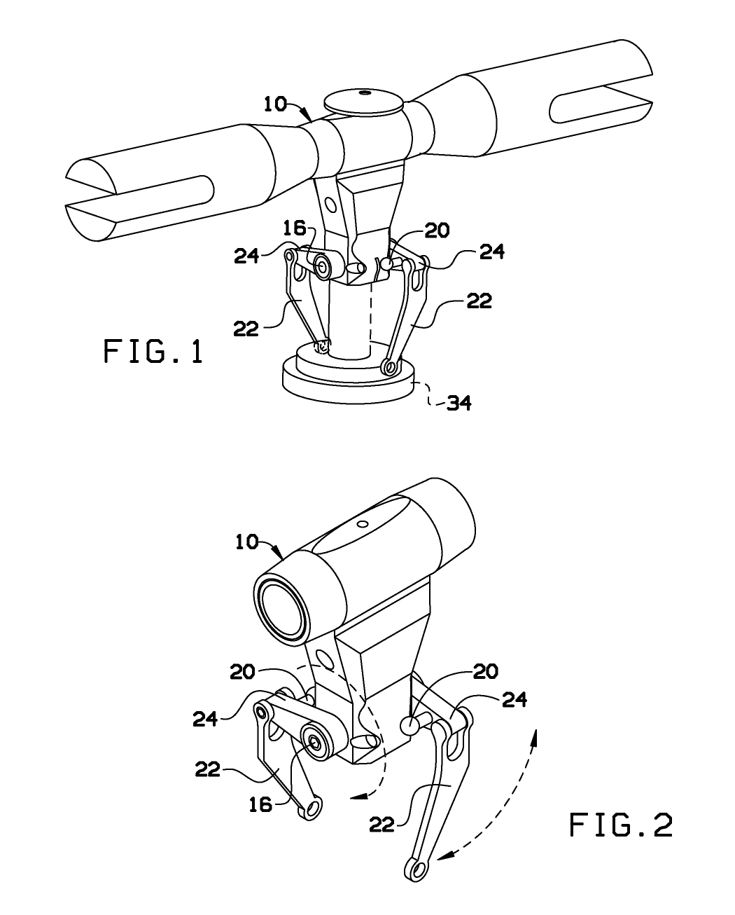

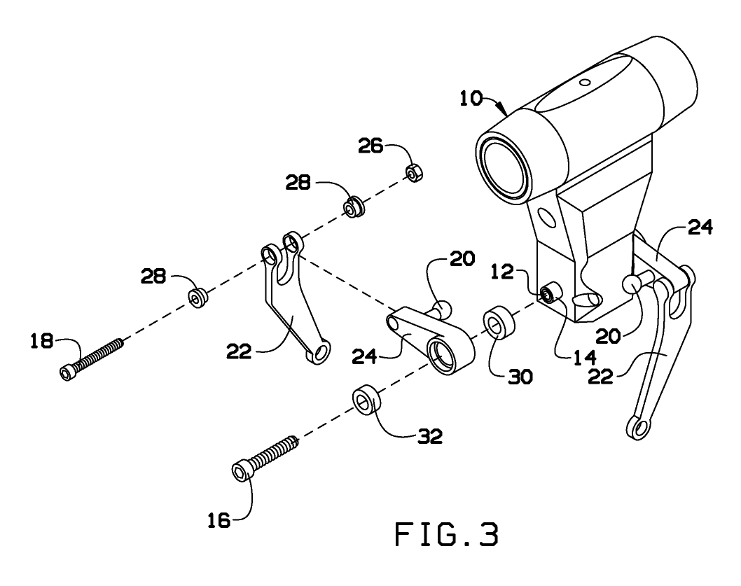

Referring now to FIGS. 1 through 3, the center hub (yoke) 10 has two protruding support studs 14 with a threaded hole 12 at its end for a retaining screw 16 for mounting levers 24.

The levers 24 have pockets for installation of two different sized ball bearings 30, 32 at one end. At a set position on the lever 24, a linkage connection point 20 is provided. At the end of the lever 24, a connection point is provided for a linkage arm 22. The linkage arm 22 can connect to the connection point via a screw 18, passing through a flanged bearing 28, and secured with a locking nut 26. The linkage arm 22 can each attach to the swash plate 34, providing a two-point connection to the swash plate 34.

The center hub 10 can be a machine alloy or plastic. The center hub 10 can have two protruding lever support studs 14 or shoulders. Each stud 14 is positioned on the center hub 10 to allow the levers 24 to achieve a mechanical alignment to the blade grip. The studs 14 can be positioned in a way that will allow phasing of the swash plate 34 on a single connection point for the blade grip. These studs 14 have a specific outside diameter and are preset for the required ball bearing size to be used in the attached levers 24. The studs 14 can be either machined as one piece with the center hub 10 (yoke), or as a separate surface mounted insert or threaded item achieving the same function. At the studs' end surface, a threaded or through hole 12 is available for the retaining screw 16 to mount the levers 24.

The lever 24 can be either a machined alloy or plastic with a length determined upon design requirements of the size or class of helicopter. One end of the lever 24 has two ball bearing pockets—one on each side—for installation of two different size diameter ball bearings 30, 32. The ball bearing size difference is chosen to achieve strength and stability of the lever 24. In some embodiments and some configurations, the bearings 30, 32 can be designed to be the same size.

At a set position, determined by design need, either a threaded hole for a separate threaded removable standoff as a connection point, or a threaded standoff manufactured as a joint part of the lever for a linkage connection point is provided. These optional connection points can be used for control input to the aligned blade grip. The other end of the lever 24 has a connection point for either a ball bearing 28 raced or pinned linkage arm 22 connection (with a bushing, for example) to the swash plate 34.

The levers 24 can mounted to the center hub 10 via studs 14 and can retained by one screw or bolt 16. In some embodiments, the bolt 16 can be a threaded rod that goes through the shaft and the levers 24 are attached on each end.

The linkage 22 can connect to the swash plate 34 in various ways. For example, the linkage 22 can connect to the swash plate 34 via ball 20.

It should be understood, of course, that the foregoing relates to exemplary embodiments of the invention and that modifications may be made without departing from the spirit and scope of the invention as set forth in the following claims.

What is claimed is:

1. A flybarless helicopter rotor head system comprising:
a center hub having two protruding support studs with holes at the end thereof;
a first and a second mounting lever attached to the center hub;
first and second ball bearings used to attach each of the first and second mounting levers to the support studs; and
a first and a second linkage arm attached to ends of the first and second mounting levers, wherein the first and second linkage arms provides a two-point attachment to a swash plate.

2. The flybarless helicopter rotor head system of claim 1, wherein the first and second ball bearings are of different sizes.

3. The flybarless helicopter rotor head system of claim 1, wherein the support studs are formed integrally with the center hub.

4. The flybarless helicopter rotor head system of claim 1, wherein the support studs are removable from the center hub.

5. The flybarless helicopter rotor head system of claim 1, further comprising a shoulder bearing interconnecting the first and second linkage arms to the first and second mounting levers.

6. The flybarless helicopter rotor head system of claim 1, wherein the first and second mounting levers are attached to the center hub with mounting screws.

7. The flybarless helicopter rotor head system of claim 1, wherein the holes in the support studs are at least partially threaded holes.

8. A flybarless helicopter rotor head system comprising:
a center hub having two protruding support studs with threaded holes at the end thereof;
a first and a second mounting lever attached to the center hub with mounting screws threaded into the holes of the center hub;
first and second ball bearings used to attach each of the first and second mounting levers to the support studs; and
a first and a second linkage arm attached to ends of the first and second mounting levers, wherein the first and second linkage arms provides a two-point attachment to a swash plate.

9. The flybarless helicopter rotor head system of claim 8, wherein the first and second ball bearings are of different sizes.

10. The flybarless helicopter rotor head system of claim 8, wherein the support studs are formed integrally with the center hub.
